(19) United States
(12) Patent Application Publication
(10) Pub. No.: US 2014/0176429 A1
(43) Pub. Date: Jun. 26, 2014

(54) FLEXIBLE ELECTRONIC DEVICE AND METHOD FOR CONTROLLING FLEXIBLE ELECTRONIC DEVICE

(71) Applicant: FIH (Hong Kong) Limited, Kowloon (HK)

(72) Inventor: HSING-CHUN HSIEH, New Taipei (TW)

(73) Assignee: FIH (HONG KONG) LIMITED, Kowloon (HK)

(21) Appl. No.: 14/135,603

(22) Filed: Dec. 20, 2013

(30) Foreign Application Priority Data
Dec. 24, 2012 (TW) 101149652

(51) Int. Cl. G09G 5/00; G06F 1/16

(52) U.S. Cl. CPC G09G 5/006; G06F 1/1652
USPC 345/156

(57) ABSTRACT

In a method for controlling a flexible electronic device to sleep or restart, current position data of two gravity sensors located at opposite sides of a flexible display of the flexible electronic device is received. A distance between the two gravity sensors is detected by a proximity sensor located at one of the opposite sides of the flexible display. A control unit of the flexible electronic device controls the flexible electronic device to sleep or restart according to the current position data and the distance.

### CROSS-REFERENCE TO RELATED APPLICATIONS

This application claims all benefits accruing under 35 U.S.C. §119 from Taiwan Patent Application No. 101149652, filed on Dec. 24, 2012 in the Taiwan Intellectual Property Office, the content of which is hereby incorporated by reference. This application is related to commonly-assigned applications entitled, “FLEXIBLE ELECTRONIC DEVICE AND METHOD FOR CONTROLLING FLEXIBLE ELECTRONIC DEVICE”, Atty. Docket No. US47349.

### BACKGROUND

1. Technical Field

Embodiments of the present disclosure generally relate to electronic devices, and particularly to a flexible electronic device and a method for controlling the flexible electronic device.

2. Description of Related Art

Flexible display devices may be used in electronic devices. When the flexible display device of the electronic device is bent, data (such as images or text) can be normally displayed on the flexible display device. However, at present, touch gestures used for controlling normal touch panels are used for controlling the electronic device configured with the flexible display device to sleep or restart. Therefore, there is room for improvement in the art.

### BRIEF DESCRIPTION OF THE DRAWINGS

FIG. 1 is a block diagram of one embodiment of a flexible electronic device including a control unit.

FIG. 2 is one embodiment illustrating a proximity sensor and two gravity sensors of the flexible electronic device of FIG. 1.

FIG. 3 is a block diagram of one embodiment of function modules of the control unit in FIG. 1.

FIG. 4 illustrates one embodiment of a coordinate system in relation to the gravity sensors of FIG. 2.

FIG. 5-FIG. 6 are embodiments illustrating a process of controlling the flexible electronic device in FIG. 1

FIG. 7 is a flowchart of one embodiment of a method for controlling the flexible electronic device in FIG. 1.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean “at least one.”

In general, the word “module”, as used herein, refers to logic embodied in hardware or firmware, or to a collection of software instructions, written in a programming language. One or more software instructions in the modules may be embedded in hardware, such as in an erasable programmable read only memory (EPROM). The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

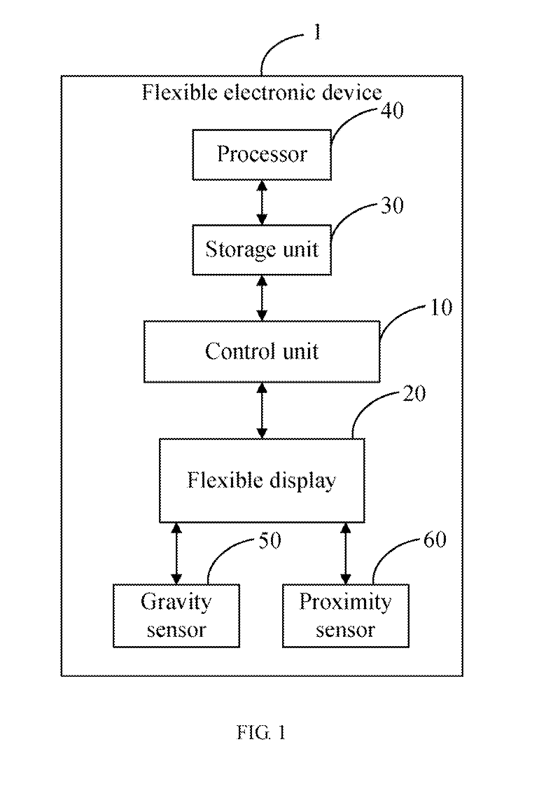

FIG. 1 is a block diagram of one embodiment of a flexible electronic device 1. In the embodiment, the flexible electronic device 1 includes a control unit 10, a flexible display 20, a storage unit 30, a processor 40, a plurality of gravity sensors 50 (only one is shown in FIG. 1), and a proximity sensor 60. In one embodiment, the flexible electronic device 1 is a mobile phone, but the disclosure is not limited thereto.

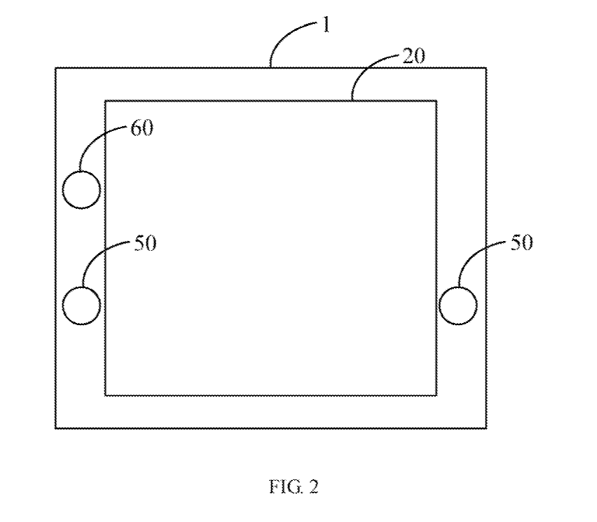

In one embodiment, as shown in FIG. 2, the flexible electronic device 1 includes two gravity sensors 50, which are located at opposite sides (e.g., a left side and a right side) of the flexible display 20. The proximity sensor 60 is located at one of the opposite sides (e.g., the left side) of the flexible display 20. When a user bends the flexible electronic device 1, the gravity sensors 50 detect current positions of the opposite sides of the flexible electronic device 1, and the proximity sensor 60 detects distance between the opposite sides of the flexible electronic device 1. In one embodiment, the distance between the opposite sides of the flexible electronic device 1 is equal to a distance between the two gravity sensors 50. The gravity sensors 50 and the proximity sensor 60 send the current positions and the distance to the control unit 10. The control unit 10 controls the flexible electronic device 1 to sleep or restart according to the current positions and the distance.

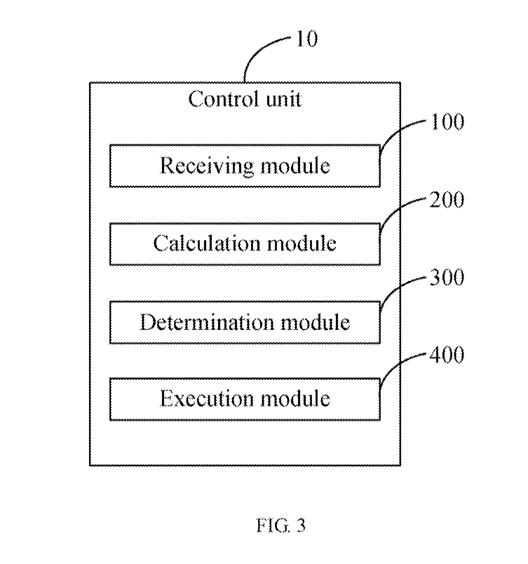

In one embodiment, the control unit 10 includes one or more function modules (as shown in FIG. 3). The one or more function modules may include computerized code in the form of one or more programs that are stored in the storage unit 30, and executed by the processor 40 to provide functions of the control unit 10. The storage unit 30 may be a dedicated memory, such as an EPROM or a flash memory.

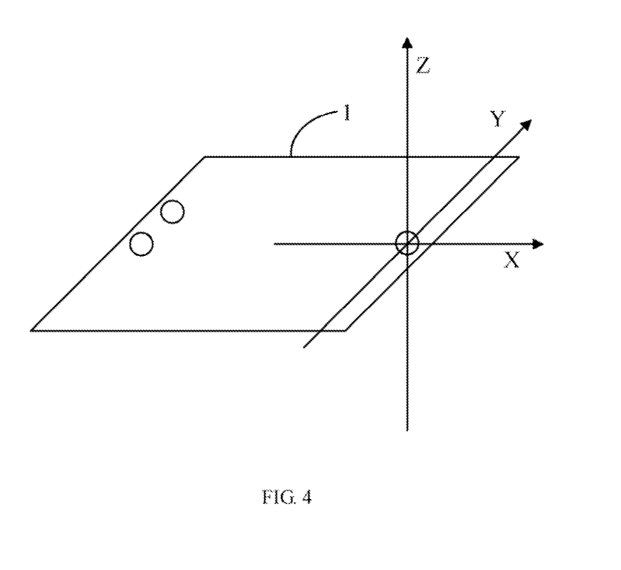

FIG. 3 is a block diagram of one embodiment of the function modules of the control unit 10. In one embodiment, the control unit 10 includes a receiving module 100, a calculation module 200, a determination module 300, and an execution module 400. Descriptions of functions of the modules 100-400 are given with reference to FIG. 4-FIG. 7.

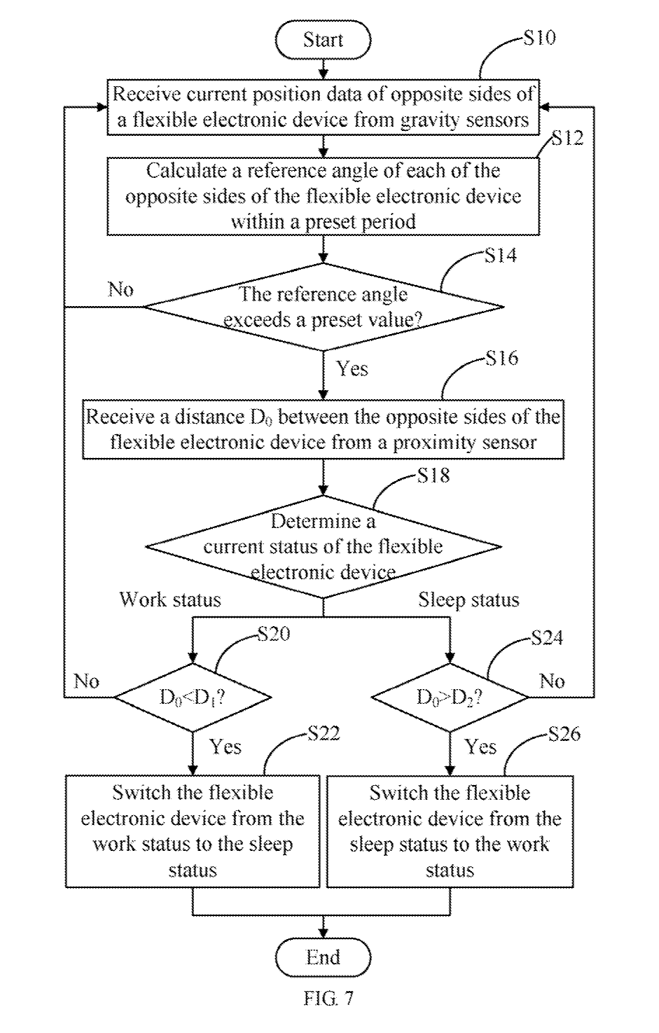

FIG. 7 is a flowchart of one embodiment of a method for controlling the flexible electronic device 1 to sleep or restart. Depending on the embodiment, additional steps may be added, others removed, and the ordering of the steps may be changed.

In step S10, the receiving module 100 receives current position data of opposite sides (e.g., a left side and a right side) of the flexible electronic device 1 from the gravity sensors 50. In the embodiment, the current position data of the opposite sides of the flexible electronic device 1 is equal to a current position data of corresponding gravity sensor 50. The current position data of the gravity sensor 50 is represented by a XYZ coordinate system. As shown in FIG. 4, the flexible electronic device 1 lies in the XY plane, and the Z-axis is perpendicular to a front surface of the flexible electronic device 1.

In step S12, the calculation module 200 calculates a reference angle of each of the opposite sides of the flexible electronic device 1 within a preset period (e.g., two seconds). In one embodiment, the reference angle is defined as an angle change between a previous position of the sides of the flexible electronic device 1 and a current position of the sides of the flexible electronic device 1.

In step S14, the determination module 300 determines whether the reference angle of one of the opposite sides of the flexible electronic device 1 exceeds a preset value. In one embodiment, the preset value is ninety degrees. If the reference angle of either one of the opposite sides of the flexible electronic device 1 exceeds the preset value, step S16 is implemented. If neither of the reference angles of the opposite sides of the flexible electronic device 1 exceeds the preset value, the procedure returns to step S10.

In step S16, the receiving module 100 receives a distance D₀ between the opposite sides of the flexible electronic device 1 from the proximity sensor 60. In one embodiment, the distance D₀ between the opposite sides of the flexible electronic device 1 is equal to a distance between the two gravity sensors 50.

In step S18, the determination module 300 determines a current status of the flexible electronic device 1. In one embodiment, the status includes a sleep status and a work status. If the flexible electronic device 1 is in the work status, steps S20-S22 are implemented. If the flexible electronic device 1 is in the sleep status, steps S24-S26 are implemented.

In step S20, the determination module 300 determines whether the distance D₀ is less than a first preset distance D₁. In one embodiment, the first preset distance D₁ is one centimeter. If the distance D₀ is less than the first preset distance D₁, step S22 is implemented. If the distance D₀ is more than or equal to the first preset distance D₁, the procedure returns to step S10.

In step S22, the execution module 400 switches the flexible electronic device 1 from the work status to the sleep status. Then, the procedure ends.

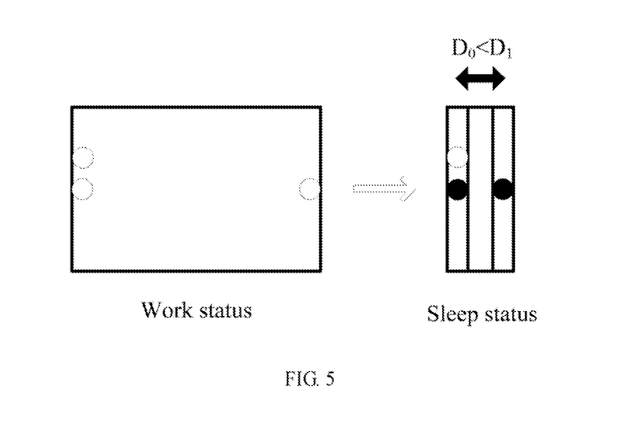

For example, as shown in FIG. 5, the flexible electronic device 1 is first in the work status. When the flexible electronic device 1 is bent by a user so that the angle change of the sides of the electronic device is greater than a determined number of degrees (e.g., ninety degrees), and the distance D₀ is less than the first preset distance D₁, the flexible electronic device 1 is switched to the sleep status.

In step S24, the determination module 300 determines whether the distance D₀ is more than a second preset distance D₂. In one embodiment, the second preset distance D₂ is three centimeters. If the distance D₀ is more than the second preset distance D₂, step S26 is implemented. If the distance D₀ is less than or equal to the second preset distance D₂, the procedure returns to step S10.

In step S26, the execution module 400 switches the flexible electronic device 1 from the sleep status to the work status. Then, the procedure ends.

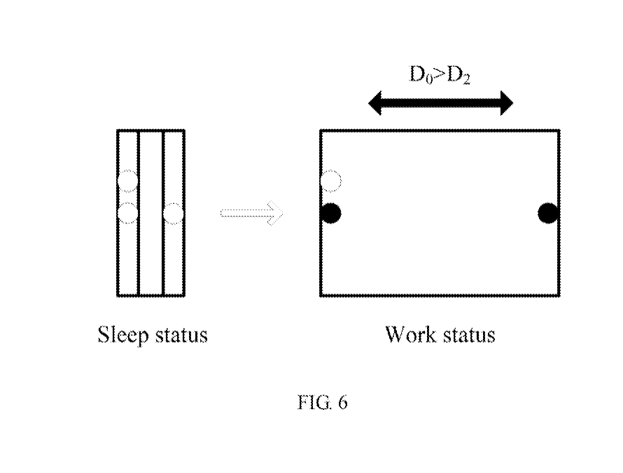

For example, as shown in FIG. 6, the flexible electronic device 1 is first in the sleep status. When the flexible electronic device 1 is unbent so that the angle change of the sides of the electronic device is greater than the determined number of degrees (e.g., ninety degrees), and the distance D₀ is more than the second preset distance D₂, the flexible electronic device 1 is switched to the work status.

Although certain embodiments of the present disclosure have been specifically described, the present disclosure is not to be construed as being limited thereto. Various changes or modifications may be made to the present disclosure without departing from the scope and spirit of the present disclosure.

What is claimed is:

1. A method being executed by a processor of a flexible electronic device, the flexible electronic device comprising a flexible display, a plurality of gravity sensors and a proximity sensor, the method comprising:
(a) receiving current position data of two gravity sensors of the flexible electronic device, wherein the two gravity sensors are positioned at opposite sides of the flexible display;
(b) calculating a reference angle of each of the opposite sides of the flexible electronic device within a preset period according to the current position data, and determining whether the reference angle of one of the opposite sides of the flexible electronic device exceeds a preset value;
(c) receiving a distance between the two gravity sensors from the proximity sensor located at one of the opposite sides of the flexible display, in response to determining that the reference angle of either one of the opposite sides of the flexible electronic device exceeds the preset value;
(d) switching the flexible electronic device from a work status to a sleep status, in response to determining that the flexible electronic device is first in the work status and the distance between the opposite sides of the flexible electronic device is less than a first preset distance; or
(e) switching the flexible electronic device from the sleep status to the work status, in response to determining that the flexible electronic device is first in the sleep status and the distance between the opposite sides of the flexible electronic device is more than a second preset distance.

2. The method as claimed in claim 1, wherein the current position data is represented by a XYZ coordinate system.

3. The method as claimed in claim 1, wherein the reference angle is defined as an angle change between a previous position of the sides of the flexible electronic device and a current position of the sides of the flexible electronic device.

4. A non-transitory storage medium storing a set of instructions, the set of instructions being executed by a processor of a flexible electronic device comprising a flexible display, a plurality of gravity sensors and a proximity sensor, to perform a method comprising:
(a) receiving current position data of two gravity sensors of the flexible electronic device, wherein the two gravity sensors are positioned at opposite sides of the flexible display;
(b) calculating a reference angle of each of the opposite sides of the flexible electronic device within a preset period according to the current position data, and determining whether the reference angle of one of the opposite sides of the flexible electronic device exceeds a preset value;
(c) receiving a distance between the two gravity sensors from the proximity sensor located at one of the opposite sides of the flexible display, in response to determining that the reference angle of either one of the opposite sides of the flexible electronic device exceeds the preset value;
(d) switching the flexible electronic device from a work status to a sleep status, in response to determining that the flexible electronic device is first in the work status and the distance between the opposite sides of the flexible electronic device is less than a first preset distance; or
(e) switching the flexible electronic device from the sleep status to the work status, in response to determining that the flexible electronic device is first in the sleep status and the distance between the opposite sides of the flexible electronic device is more than a second preset distance.

5. The non-transitory storage medium as claimed in claim 4, wherein the current position data is represented by a XYZ coordinate system.

6. The non-transitory storage medium as claimed in claim 4, wherein the reference angle is defined as an angle change between a previous position of the sides of the flexible electronic device and a current position of the sides of the flexible electronic device.

7. A flexible electronic device, the flexible electronic device comprising:
a flexible display;
a plurality of gravity sensors located at opposite sides of the flexible display;
a proximity sensor located at one of the opposite sides of the flexible display;
at least one processor; and
a storage unit storing one or more programs, when executed by the at least one processor, causing the at least one processor to:
receive current position data of two gravity sensors of the flexible electronic device;
calculate a reference angle of each of the opposite sides of the flexible electronic device within a preset period according to the current position data, and determine whether the reference angle of one of the opposite sides of the flexible electronic device exceeds a preset value;
receive a distance between the two gravity sensors from the proximity sensor, in response to determining that the reference angle of either one of the opposite sides of the flexible electronic device exceeds the preset value;
switch the flexible electronic device from a work status to a sleep status, in response to determining that the flexible electronic device is first in the work status and the distance between the opposite sides of the flexible electronic device is less than a first preset distance; or
switch the flexible electronic device from the sleep status to the work status, in response to determining that the flexible electronic device is first in the sleep status and the distance between the opposite sides of the flexible electronic device is more than a second preset distance.

8. The flexible electronic device as claimed in claim 7, wherein the current position data is represented by a XYZ coordinate system.

9. The flexible electronic device as claimed in claim 7, wherein the reference angle is defined as an angle change between a previous position of the sides of the flexible electronic device and a current position of the sides of the flexible electronic device.
